(19) United States
(12) Patent Application Publication
(10) Pub. No.: US 2005/0229102 A1
(43) Pub. Date: Oct. 13, 2005

(54) System and method for providing an interactive display

(75) Inventors: Marieke Iwema Watson, Seattle, WA (US); Kelly E. Rollin, Seattle, WA (US); Oliver C. Lee, Redmond, WA (US); Stephen P. Proteau, Bothell, WA (US); Colin R. Anthony, Kirkland, WA (US); Robert M. Girling, Kirkland, WA (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/821,969

(22) Filed: Apr. 12, 2004

(51) Int. Cl. G06F 3/00

(52) U.S. Cl. 715/739; 715/810; 715/825

(57) ABSTRACT

The present invention is directed to a method and system for organizing and displaying items for a user interface. The method includes providing a plurality of three-dimensional items, each three-dimensional item representing user information, and arranging the three-dimensional items around a perimeter, wherein the perimeter forms a portion of a closed area. The closed area may be an ellipse, circle, or other geometric shape. The three-dimensional items include at least one item in a focus position. Typically the three-dimensional items will also include at least one item in a peripheral position and may also include background items. The items are capable of rotating around the perimeter. Additionally, the method and system may scale the items in a manner appropriate to a position along the perimeter. The method and system additionally provide for rotation of the items around the perimeter upon receiving a user request.

### CROSS-REFERENCE TO RELATED APPLICATIONS

None

### STATEMENT REGARDING FEDERALLY SPONSORED RESEARCH OR DEVELOPMENT

None.

### TECHNICAL FIELD

Embodiments of the present invention relate to visual presentation of items to a user via a user interface and more particularly to innovative solutions for presenting content to the user.

### BACKGROUND OF THE INVENTION

Today, items and files stored on a computer are usually presented to the user through lists. Lists are efficient tools for organizing and providing access to both small and large sets of items. However, lists are neither exciting nor engaging for the user.

Currently, operating systems such as Microsoft Windows, created by the Microsoft Corporation of Redmond, Wash., do not include many options for presenting items in an interesting or visually appealing manner. In contrast, the Internet is rapidly growing and offers visual options provided by Flash, Hypertext Markup Language (HTML), and Extensible Markup Language (XML). Whereas the aforementioned Internet tools allow users to create interesting views and exciting and innovative ways to present content, the presentation of content in the Windows operating system has not substantially changed for many years.

To keep pace with the developments occurring in the Internet environment, the operating system environment will be required to advance beyond presentation of items using static lists. For instance, an appropriate solution may implement imagery, interaction, motion, time, and space in creative ways to attract and retain a user's attention.

Furthermore, whereas a standard list presentation system is effective for promoting one item above another, or highlighting specific information like branding, status, or relevant tasks, it does not allow independent hardware vendors (IHVs) the opportunity to promote themselves in a unique and identifiable fashion to users, beyond their own websites, printed documentations, or on the shelves in the store.

Accordingly, a presentation solution is needed that will capture the interest of the user by presenting items in a dynamic manner for user interaction. Furthermore, a solution is needed that will allow IHVs to offer uniquely identifiable presentations to improve the user experience.

### BRIEF SUMMARY OF THE INVENTION

Embodiments of the present invention are directed to a method for organizing and displaying items for a user interface. In one aspect, the method of the invention includes providing a plurality of three-dimensional items, each three-dimensional item representing user information. The method additionally includes arranging the three-dimensional items along a perimeter, wherein the perimeter forms a portion of a closed area and the three-dimensional items include a focus item along the perimeter. In embodiments of the invention, at least one peripheral item is positioned adjacent the focus item. The perimeter may include for example, an elliptical arc, a circular arc, or a rectangular or triangular edge. Furthermore, the three-dimensional items may be capable of rotating around the perimeter.

In yet a further aspect, the invention is directed to a system for organizing and displaying information to a user. The system includes item controls for displaying a plurality of three-dimensional items, each three-dimensional item providing access to information. The system additionally includes orientation controls for arranging the items around a perimeter that forms a portion of a closed area and scalability controls for scaling a focus item to have a first set width and at least one peripheral item to have a second set width. The second set width is smaller than the first set width. The system may also include a rotation control module for allowing the three-dimensional items to rotate around the perimeter.

### BRIEF DESCRIPTION OF THE DRAWINGS

The present invention is described in detail below with reference to the attached drawings figures, wherein:

FIG. 1 is a block diagram illustrating components of a user interface presentation system in accordance with an embodiment of the invention;

FIG. 2 is a block diagram illustrating a computerized environment in which embodiments of the invention may be implemented;

FIG. 3 is a block diagram illustrating a carousel display control module in accordance with an embodiment of the invention;

FIG. 4 is a block diagram illustrating a carousel configuration in accordance with an embodiment of the invention;

FIG. 5 illustrates a one-item carousel in accordance with an embodiment of the invention;

FIG. 6A and FIG. 6B illustrate a two-item carousel in accordance with an embodiment of the invention;

FIG. 7 illustrates a carousel view with user rotation controls in accordance with an embodiment of the invention; and

FIG. 8 is a flow chart illustrating the process of changing a carousel view in accordance with an embodiment of the invention.

### DETAILED DESCRIPTION OF THE INVENTION

System Overview

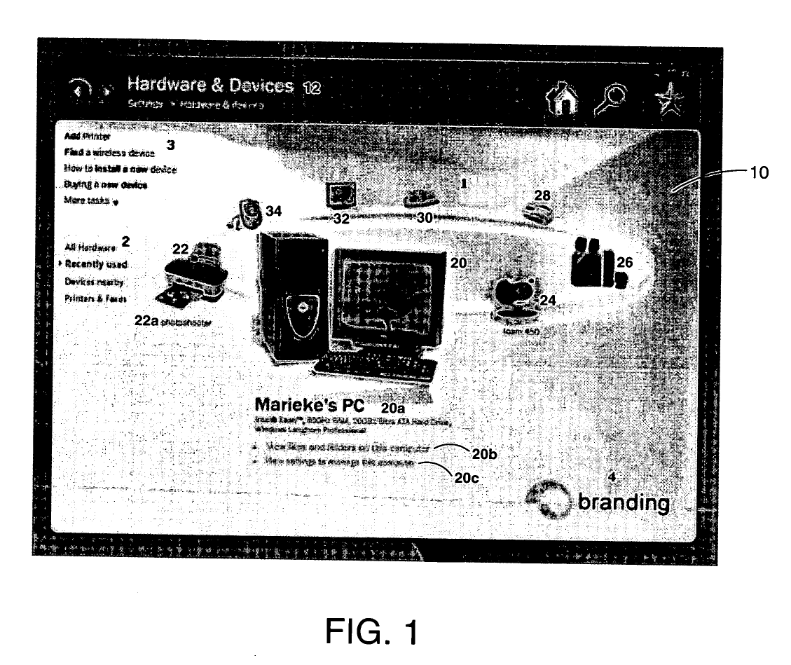

Embodiments of the present invention are directed to a system and method for presenting items to a user. FIG. 1 illustrates an example of a display system 10 in accordance with an embodiment of the invention. A series of three-dimensional display items 20, 22, 24, 26, 28, 30, 32, and 34 is shown in a carousel display 1. The carousel display 1 exposes a list of devices on which the user is currently pivoted. In the displayed embodiment, the display items 20, 22, 24, 26, 28, 30, 32, and 34 in the carousel display 1 include hardware items.

In the displayed embodiment, a centrally located or focus item 20 is a personal computer (PC). The PC 20 includes a caption 20a and user selectable options 20b and 20c. Option 20b allows a user to select to view files and folders on the PC 20. Option 20c allows a user to view settings to manage the PC 20. Items 22 and 24 are peripheral items that are directly adjacent to the centrally located item 20. Item 22 includes a photo shooter having a caption 22a and item 24 includes an Icam 24 having a caption 24a. The carousel display 1 provides a way to supply additional information by bringing items to the focus position based on status, importance, history, or other factors. Status may include “new”, “in need of repair”, or other similar factors. History may include information regarding the recent use of the item. The most recently used items may be placed closest to the focus position.

A set of pivots 2 allows a user to alter a carousel display 1 by selecting an alternate set of pivots. In the displayed embodiment, the user may select to display all hardware, recently used hardware, devices nearby, or printers and facsimile machines.

A set of tasks 3 includes a set of hard-coded tasks that may be provided by an operating system such as Microsoft Windows. The tasks shown allow a user to add or locate devices within the displayed hardware carousel or perform other hardware-related tasks. Using the displayed options, a user may add a printer, find a wireless device, or receive instructions for installing or buying a new device.

A display heading 12 highlights the current pivots. In the displayed embodiment, the pivots include hardware devices. A branding image 4 is shown on the display system for indicating the origin of the PC 20.

The carousel display 1 may appear as a tilted circle, ellipse, or other geometric shape in a three-dimensional environment. The carousel view of the invention presents a limited set of items in a visually appealing and dynamic way. The use of a closed curve such as a circle or ellipse provides a clear overview of information items available to the user. The circular or elliptical configuration may further introduce an element of play. A user may click an item to cause all items to rotate or “spin the carousel”.

Exemplary Operating Environment

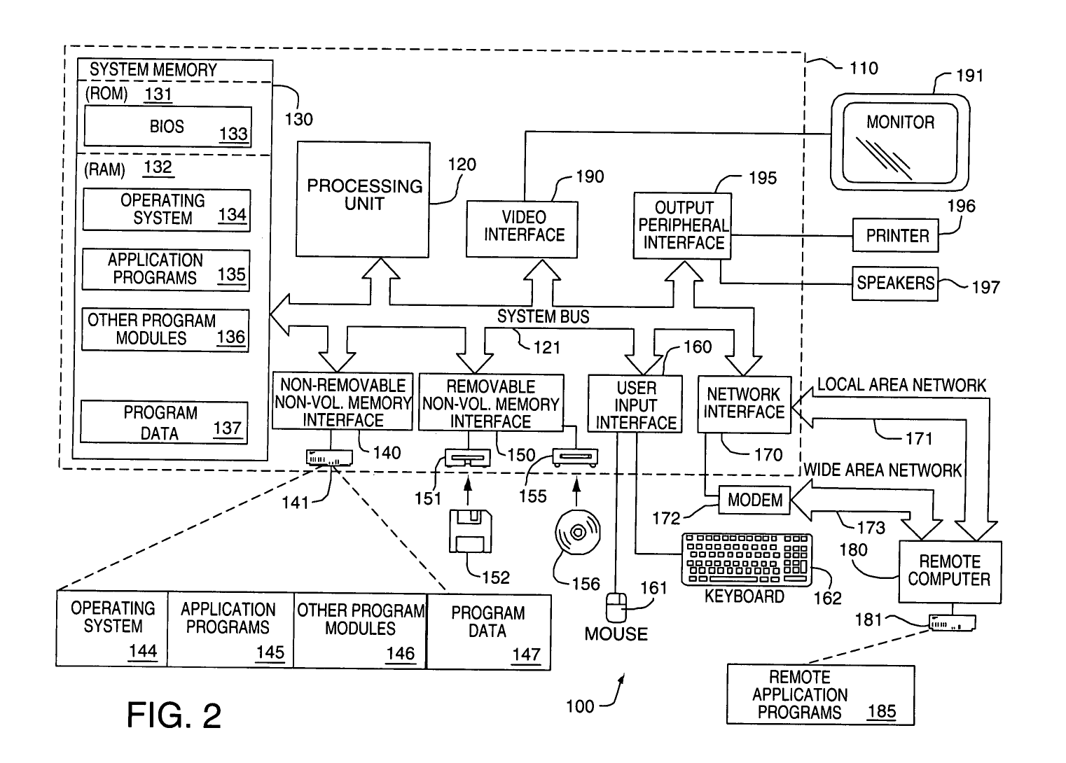

FIG. 2 illustrates an example of a suitable computing system environment 100 for a computer on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

Carousel Display Module

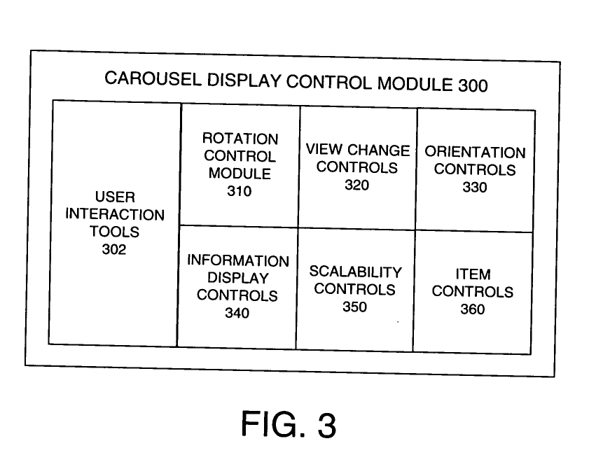

Since the carousel displayed in FIG. 1 is a three-dimensional display, it may be built on a three-dimensional rendering infrastructure. Alternatively, the desired effects can be implemented in 2.5D by layering two-dimensional objects and scaling objects according to distance. The carousel is responsible for item layout and formatting, animations, and three-dimensional item management. FIG. 3 illustrates a carousel display control module 300 that is equipped for rendering and altering the carousel display 1 as shown in FIG. 1. The carousel display control module 300 may include user interaction tools 302, a rotation control module 310, view change controls 320, orientation controls 330, information display controls 340, scalability controls 350, and item controls 360.

User interaction tools 302 provide for user selection such as those made through the selectable tasks 2 or selectable pivots 3. As illustrated above, the focus item 20 is displayed larger than the other displayed items. The focus item 20 may also be displayed with more metadata such as an item name and with a plurality of selectable tasks as illustrated in FIG. 1. Additionally, in embodiments of the invention, the background items may appear with names combined with tasks, metadata, or status. The user can single-click, double-click, right-click, or hover on any item or metadata, such as selectable tasks associated with a given item to act on the item. User interaction tools 302 are further described below in conjunction with the method of the invention.

The rotation control module 310 may be used to rotate display items around the carousel upon receiving a request from the user interaction tools 302. The rotation control module 310 preferably operates by computing an angle associated with a starting point and an angle associated with an ending point. The rotation control module 310 may interpolate between the two angles using standard circular or elliptical equations in order to rotate an item to become a focus item when selected and also to rotate the carousel into place when a view is initialized. Custom animation the carousel implements may be a translation animation to rotate items along an arc of the circular or elliptical configuration provided.

The view change controls 320 control the displayed motion of items during rotation or other action. Items may show motion when a view is opened such that items begin to appear. Items may also show motion when a view has been idle for a pre-set time period. In this instance, items may rotate, wiggle, pulse etc. The view change controls 320 may also cause items to show motion when a new item is added, removed or disappears. Furthermore, when a user hovers over an item, the item may show additional information, may become larger, or may move to the focus position. When a user clicks an item, the item may change size, shape, or color. Alternatively, if new or urgent information about an item becomes available, the view of the item may change.

Orientation controls 330 may provide perspectives and orientations for the carousel. A focus item, such as item 20 from FIG. 1 is displayed in the front and foremost position on the carousel. Different shapes for the carousel may include an ellipse, a circle, or other geometric shapes. The ellipse may vary between a flat and round configuration. Sub-carousels may be displayed in addition to or as part of a large ellipse or circle. It may be possible to drill down from one carousel into a lower level carousel. This process may be used for drilling down to a carousel of files within a folder carousel.

Information display controls 340 may control metadata display and task options associated with each item of the carousel. Metadata can be shown exclusively for the focus item in the front or may also be displayed for additional items. Information display controls 340 may display additional information when a user hovers on other items in the carousel. If new or urgent information about an item becomes available, the information display controls 340 may indicate that the item is in need of repair or is unavailable. The information display controls 340 can further be used for determining a layout order of items.

Scalability controls 350 operate based on a three-dimensional layout algorithm for positioning items around the carousel. In an embodiment of the invention, the scalability controls 350 operate so as to cause the items to appear to be equidistant along an arc of a circle or an ellipse that is rotated about its axis by a constant angle. The scalability controls 350 may magnify the size of the front three items including the focus item and the two peripheral items for greater emphasis. Furthermore, as set forth above, labels may be provided for the front three items and may be omitted for the background items. The focus item may include a preview pane that displays a set number of property fields in addition to a set number of actionable tasks associated with the focus item.

The number of items that fit within the carousel display 1 depends on the size of the window provided. For example, about twenty-five carousel items will fit in a standard window of 1024×768 pixels. As the number of items in the carousel increases, the scalability controls 350 may decrease the size of each item in order to maximize available space. When the background items have reached their smallest size, which is 16×16 pixels in accordance with an embodiment of the invention, and a pre-selected minimum space between items has been reached, the scalability controls 350 may exercise one of several options.

First, new items may be incorporated in an overflow menu. The overflow menu may display one item that indicates that access to additional items is available. For instance, clicking on the item would show a list or menu of the additional items that the carousel lacked space to show individually. Secondly, the scalability controls 350 could increase the carousel beyond the size of the window to fit more items. In this instance, the scalability controls 350 may provide scrollbars in order to allow a user to scroll to view the entire carousel. Thirdly, the scalability controls 350 could utilize a threshold to determine that a maximum carousel size has been reached and change the display view to show a list instead of a carousel or could scale down distant items to fade into a cloud.

Item controls 360 create the three-dimensional items for the carousel corresponding to the two-dimensional items provided in a standard list view. The scalability controls 350, the rotation controls 310, and the view change controls 320 operate on the created items as described above.

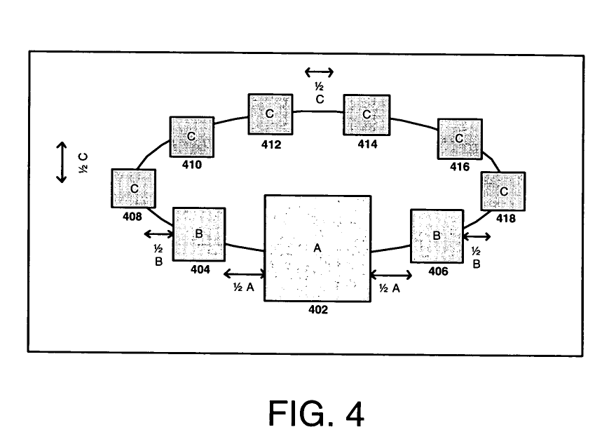

FIG. 4 illustrates relative dimensions of a carousel view in accordance with an embodiment of the invention. A plurality of display items 402, 404, 406, 408, 410, 412, 416, and 418 are displayed around the carousel. Item 402, labeled as having a width “A”, is the centrally located focus item. Peripheral items 404 and 406, labeled as having a width “B”, are adjacent item 402 on either side. The distance between item 402 and 406 and between item 402 and item 404 is equal to ½ A. Background items including items 408, 410, 412, 414, 416, and 418 are labeled as having a width “C”. The distance between the peripheral items 404 and 406 and the background items 408 and 410 respectively is equal to ½ B. The distance between adjacent background items is shown as being equal to ½ C.

In the embodiment displayed in FIG. 4, the carousel is an ellipse having a height to width ratio of three to ten. For an 800×600 pixel window, the carousel display may include 400×120 pixels. The size of the provided items may be from 16×16 to 128×128 pixels. In this instance, several relative dimensioning schemes are possible for items A, B, and C. In a first scheme, if width A=128 pixels, then B=64 pixels, and C=48 pixels. In a second scheme, if A=96 pixels, then B=64 pixels, and C=32 pixels. In a third scheme, if A=64 pixels, then B=32 pixels and C=16 pixels. In all instances, there will be at least one element having a width A and no more than two elements having the width B. In other words, every carousel display has at least one focus item and not more than two peripheral items. The carousel display may also have multiple background items.

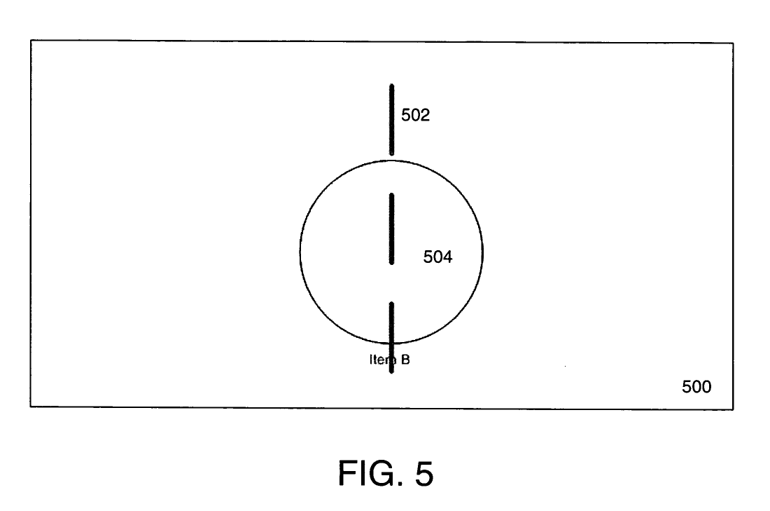

FIG. 5 illustrates a one-item carousel 500 in accordance with an embodiment of the invention. When only one item is in the view, the item is always the focus or front-most item. The focus item 504 is located along a central axis 502.

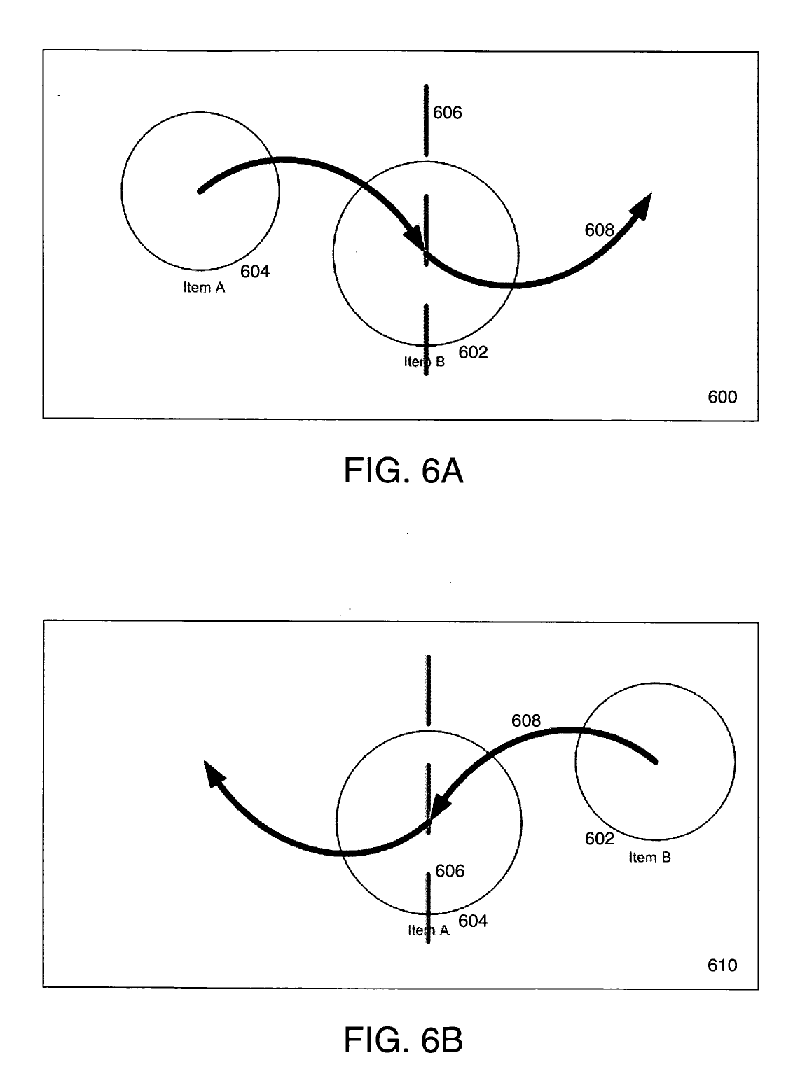

FIGS. 6A and 6B illustrate a two-item carousel in accordance with an embodiment of the invention. In FIG. 6A, a central item 602 is located along a central axis 606. A peripheral item 604 is located along the axis 608. FIG. 6B illustrates the carousel of 6A after a user has selected to change the focus to item 604. In FIG. 6B, item 604 is centrally located along the axis 606. Item 602 shifts to the right along axis 608. The scalability controls 350, shown in FIG. 3 cause both items change size in accordance with their respective positions.

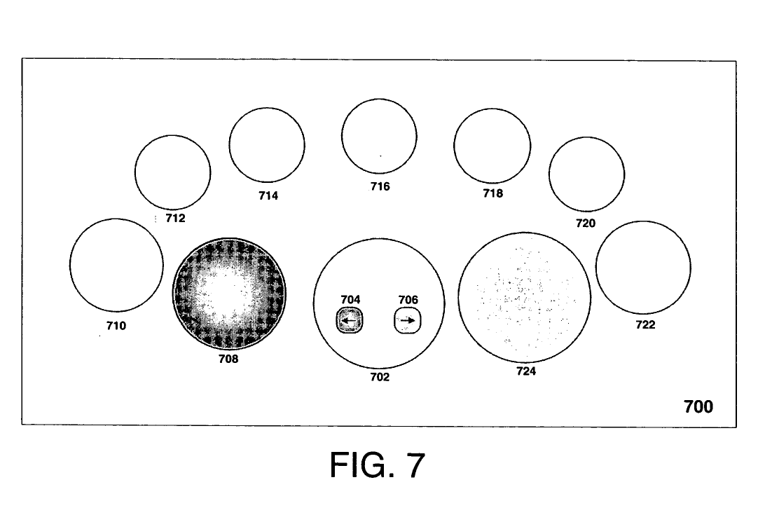

FIG. 7 illustrates a carousel view 700 including a focus item 702, peripheral items 708 and 724, and background items 710, 712, 714, 7, 16, 718, 720, and 722. The focus item 702 includes focus control mechanisms 704 and 706. Focus control mechanism 704 allows item 708 to be shifted into focus. Focus control mechanism 706 allows item 724 to be shifted into focus.

Methods of the Invention

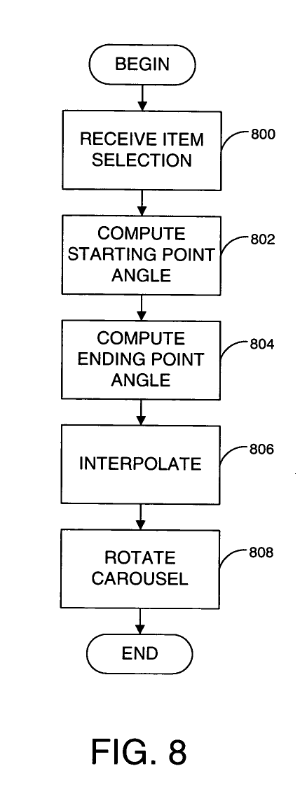

FIG. 8 illustrates a rotation method for the carousel view in accordance with an embodiment of the invention. In step 800, the carousel display control module 300 receives an item selection. In step 802, the display control module 300 computes a starting point angle. In step 804, the carousel display control module 300 selects an ending point angle. In step 806, the display control module 300 interpolates between angles, and in step 808, the display control module 300 rotates the carousel as explained above with regard to the rotation control module 310.

The carousel display control module 300 operates in conjunction with standard hardware to provide the proposed behaviors. In many instances, a user will be able to execute a single click, a double click, or a right click to obtain desired behaviors. The user may perform these operations on any of the carousel items, on a task from the task menu 3 shown in FIG. 1, or on tasks available for the focus item 20, such as 20b and 20c shown in FIG. 1. Table 1 below provides an exemplary method for connection between hardware implementations and proposed carousel behaviors.

TABLE 1

| | | | Background or |
|---|---|---|---|
| Action\| Item | Focus Item | Task | peripheral Item |
| Single click | Launch the default task. | Launch task. | Selected item will |
| | Navigate to the details | | become focus item. |
| | page. | | |
| | If the device is in need of | | |
| | repair, go to | | |
| | troubleshooter UI. | | |
| | If device is not connected, | | |
| | Try to connect. | | |
| Double Click | Treat as single click. | Treat as single click. | Default task |
| Right Click | Context menu | If selected from task | Context menu |
| | | menu, show context | |
| | | menu. | |
| | | If from below focus | |
| | | device, show context | |
| | | menu for the device. | |

The first column of table 1 lists user actions including “single click”, “double click”, and “right click”. The first row of table 1 lists the user interface items on which a user may perform the user actions. These items may include a focus item, a task menu, or a background or peripheral item.

If a user single-clicks on a focus item, a default task will be launched and the user can navigate to a details page. In the hardware example, if the focus item is in need of repair, the user will be directed to a troubleshooter UI. If the item is not connected, the system will attempt to connect. If the user double-clicks on the focus item, the double click will be treated as a single click. If the user right-clicks on the focus item, a context menu will appear.

If the user single-clicks or double-clicks on a task, the task will be launched. If the user right-clicks on the task, the context menu will appear.

If the user single-clicks on a background or peripheral item, the selected item will become the focus item. If a user double-clicks, a default task will be performed. If the user right-clicks, the context menu appears.

The aforementioned scenarios described with regard to Table 1 are merely exemplary. Other user action relationships may also be implemented. Rotation controls provided on the user interface or keyboard could be used to rotate and select items.

The carousel is optimal for smaller sets of items, for instance fewer than twenty-five items and with items having rich imagery. In accordance with embodiments of the invention, imagery can be provided by the Windows operating system. Images from the windows operating system may include standard icons or thumbnails. Images may also be provided by independent vendors or partners. For simulation of perspective, images should either simulate depth or represent three-dimensional objects.

The carousel display facilitates presentation of a limited set of items in a visually appealing and dynamic way. Providing a circle or an ellipse in three dimensions provides a clear overview at a glance of available features. The carousel provides a way to give additional information by bringing items to the front, based on status, importance, history or other factors. The carousel display also introduces an element of play. By clicking an item, a user is able to spin the carousel. This makes the view both an access point and an interesting place for the user to visit. The fact that users may want to visit the view would create an advantageous position for branding by independent vendors that might create their own items for display.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A method for organizing and displaying items for a user interface, the method comprising:
providing a plurality of three-dimensional items, each three-dimensional item representing user information; and
arranging the three-dimensional around a perimeter, wherein the perimeter forms a portion of a closed area and the three-dimensional items include a focus item and at least one peripheral item adjacent the focus item.

2. The method of claim 1, further comprising a peripheral item adjacent the focus item on each side of the focus item.

3. The method of claim 1, further comprising arranging at least one background item adjacent the peripheral item.

4. The method of claim 1, wherein arranging the three-dimensional items along a perimeter comprises arranging the three-dimensional items along an arc of an ellipse.

5. The method of claim 1, wherein arranging the three-dimensional items along a perimeter comprising arranging the three-dimensional items along an arc of a circle.

6. The method of claim 1, further comprising scaling the focus item to a first set width and scaling each peripheral item to a second set width, wherein the first set width is greater than the second set width.

7. The method of claim 3, further comprising scaling the focus item to a first set width, scaling each peripheral item to a second set width, and scaling each background item to a third set width, wherein the first set width is greater than the second set width and the second set width is greater than the third set width.

8. The method of claim 1, further comprising rotating the items around the perimeter upon receiving a user request.

9. The method of claim 8, wherein the user request comprises selection of the peripheral item, and rotating the items includes rotating the focus item to a peripheral position and the peripheral item to a focus position.

10. The method of claim 1, further comprising displaying metadata relevant to the focus item and each peripheral item.

11. The method of claim 8, wherein rotating the items comprises computing a starting point angle, computing an ending point angle, and interpolating between the computed angles.

12. A computer readable medium storing executable instructions for performing the method of claim 1.

13. A system for organizing and displaying information to a user, the system comprising:
item controls for displaying a plurality of three-dimensional items, each three-dimensional item providing access to information;
orientation controls for arranging the items around a perimeter that forms a portion of a closed area; and
scalability controls for scaling a focus item to have a first set width and at least one peripheral item to have a second set width smaller than the first set width.

14. The system of claim 13, wherein the item controls position a first peripheral item adjacent the focus item on a first side and a second peripheral item adjacent the focus item on a second side.

15. The system of claim 13, wherein the item controls arrange at least one background item adjacent the peripheral item.

16. The system of claim 13, wherein perimeter comprises an elliptical arc.

17. The system of claim 13, wherein the perimeter comprises a circular arc.

18. The system of claim 13, wherein the scalability controls further comprise means for scaling the focus item to a first set width and scaling each peripheral item to a second set width, wherein the first set width is greater than the second set width.

19. The system of claim 15, wherein the scalability controls further comprise means for scaling the focus item to a first set width, scaling each peripheral item to a second set width, and scaling each background item to a third set width, wherein the first set width is greater than the second set width and the second set width is greater than the third set width.

20. The system of claim 13, further comprising a rotation control module for rotating the items around the perimeter upon receiving a user request.

21. The system of claim 20, wherein the user request comprises selection of the peripheral item, and the rotation control module rotates the focus item to a peripheral position and the peripheral item to a focus position.

22. The system of claim 13, further comprising information display controls for displaying metadata relevant to the focus item and each peripheral item.

23. The system of claim 13, further comprising view change controls for altering an appearance of an item upon a change in item status.

24. The system of claim 13, wherein the perimeter comprises a triangular border.

25. The system of claim 13, wherein the perimeter comprises a rectangular border.
